(19) United States
(12) Patent Application Publication
(10) Pub. No.: US 2023/0362955 A1
(43) Pub. Date: Nov. 9, 2023

(54) PHYSICAL DOWNLINK CONTROL CHANNEL PARTITIONING FOR MULTI-CELL MULTI-SLOT SCHEDULING

(71) Applicant: QUALCOMM Incorporated, San Diego, CA (US)

(72) Inventors: Kazuki TAKEDA, Minato-ku (JP); Heechoon LEE, San Diego, CA (US); Jae Ho RYU, San Diego, CA (US)

(21) Appl. No.: 18/304,753

(22) Filed: Apr. 21, 2023

Related U.S. Application Data
(60) Provisional application No. 63/364,245, filed on May 5, 2022.

(51) Int. Cl. H04W 72/232; H04W 72/1273

(52) U.S. Cl. CPC H04W 72/232; H04W 72/1273

(57) ABSTRACT

Various aspects of the present disclosure generally relate to wireless communication. In some aspects, a user equipment (UE) may receive physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The UE may receive, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations. Numerous other aspects are described.

### CROSS-REFERENCE TO RELATED APPLICATION

This patent application claims priority to U.S. Provisional Patent Application No. 63/364,245, filed on May 5, 2022, entitled “PHYSICAL DOWNLINK CONTROL CHANNEL PARTITIONING FOR MULTI-CELL MULTI-SLOT SCHEDULING,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for physical downlink control channel partitioning for multi-cell multi-slot scheduling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The method may include receiving, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations.

Some aspects described herein relate to a method of wireless communication performed by a network entity. The method may include transmitting PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The method may include transmitting, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations.

Some aspects described herein relate to a UE for wireless communication. The UE may include a memory and one or more processors coupled to the memory. The one or more processors may be configured to receive PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The one or more processors may be configured to receive, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations.

Some aspects described herein relate to a network entity for wireless communication. The network entity may include a memory and one or more processors coupled to the memory. The one or more processors may be configured to transmit PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The one or more processors may be configured to transmit, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations.

Some aspects described herein relate to a non-transitory computer-readable medium that stores a set of instructions for wireless communication by a UE. The set of instructions, when executed by one or more processors of the UE, may cause the UE to receive PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The set of instructions, when executed by one or more processors of the UE, may cause the UE to receive, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations.

Some aspects described herein relate to a non-transitory computer-readable medium that stores a set of instructions for wireless communication by a network entity. The set of instructions, when executed by one or more processors of the network entity, may cause the network entity to transmit PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The set of instructions, when executed by one or more processors of the network entity, may cause the network entity to transmit, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations.

Some aspects described herein relate to an apparatus for wireless communication. The apparatus may include means for receiving PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The apparatus may include means for receiving, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations.

Some aspects described herein relate to an apparatus for wireless communication. The apparatus may include means for transmitting PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The apparatus may include means for transmitting, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of an open radio access network (O-RAN) architecture, in accordance with the present disclosure.

FIG. 4 is a diagram illustrating an example of downlink control information (DCI) that schedules multiple cells, in accordance with the present disclosure.

FIGS. 5A-5C are diagrams illustrating examples of DCI that schedules multiple cells, in accordance with the present disclosure.

FIGS. 6A-6F are diagrams illustrating examples associated with physical downlink control channel (PDCCH) partitioning for multi-cell multi-slot scheduling, in accordance with the present disclosure.

FIGS. 7-8 are diagrams illustrating example processes associated with PDCCH partitioning for multi-cell multi-slot scheduling, in accordance with the present disclosure.

FIGS. 9-10 are diagrams of example apparatuses for wireless communication, in accordance with the present disclosure.

### DETAILED DESCRIPTION

A network entity may transmit downlink control information (DCI) messages using a plurality of physical downlink control channel (PDCCH) monitoring occasions (MOs) in each slot on a scheduling cell of a first band. In this case, a user equipment (UE) may detect up to a threshold quantity of DCI messages per MO, which may be fewer DCI messages than are transmitted by the network entity. However, to blind decode PDCCH candidates (e.g., to receive the transmitted DCI messages), the UE may have to remain in an active state on a scheduling cell, which may prevent the UE from entering a reduced power state (e.g., a sleep state) on the scheduling cell.

Thus, to reduce a power consumption, rather than transmitting DCI messages in a plurality of PDCCH MOs in each slot, the network entity may transmit a plurality of DCI messages in a single PDCCH MO of each slot. This may reduce a quantity of PDCCH candidates for which the UE is to perform blind decoding to detect the transmitted DCI messages. However, in a set of possible PDCCH candidates, the UE does not know on which PDCCH candidates the transmitted DCIs are mapped. Accordingly, the UE is not able to prioritize between PDCCH decodes. As a result, the UE may decode PDCCH candidates out of order with respect to when the PDCCH candidates schedule data. In this case, the UE may decode last a PDCCH candidate that schedules data first, which may result in the UE not having enough time to configure a receiver of the UE for receiving the data.

Some aspects described herein enable partitioning of the set of PDCCH candidates for multi-cell, multi-slot scheduling. For example, a network entity may configure a UE with PDCCH candidates that are partitioned into a group of subsets, and each subset may be associated with a prioritization. In this case, the UE may decode PDCCH candidates in an order associated with the prioritization of the partitions to which the PDCCH candidates are divided. The prioritization may correspond to a time order of data scheduled by the DCI messages conveyed in the PDCCH candidates. As a result, the UE may decode a subset of PDCCH candidates associated with earlier scheduled resources before decoding other PDCCH candidates associated with later scheduled resources. Accordingly, the network entity and the UE ensure that there is adequate time to configure a receiver for receiving data scheduled by the DCI in the PDCCH candidates. In this way, by partitioning a set of PDCCH candidates and associating decoding prioritizations with the partitions, the network entity and the UE improve communication performance by reducing a likelihood of dropped communications. Additionally, the network entity and the UE enable the UE to transition to a power saving mode during a remainder of a slot after receipt of the PDCCH candidates, thereby reducing power consumption.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

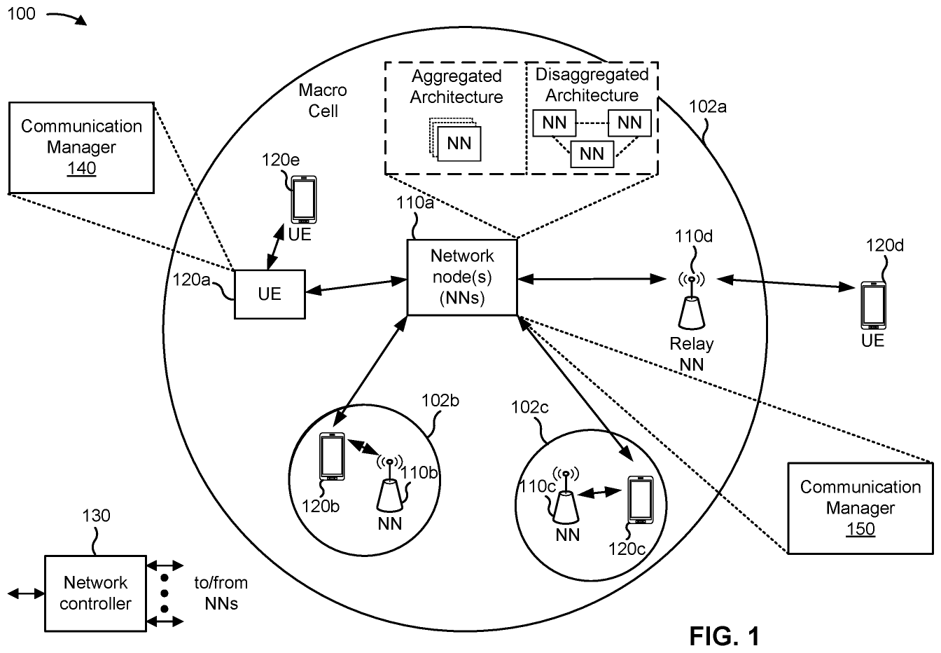

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station,” “network entity,” or “network node” may refer to an aggregated base station, a disaggregated base station, an integrated access and backhaul (IAB) node, a relay node, or one or more components thereof. For example, in some aspects, “base station,” “network entity,” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station,” “network entity,” or “network node” may refer to one device configured to perform one or more functions, such as those described herein in connection with the network node 110. In some aspects, the terms “base station,” “network entity,” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station,” “network entity,” or “network node” may refer to any one or more of those different devices. In some aspects, the terms “base station,” “network entity,” or “network node” may refer to one or more virtual base stations or one or more virtual base station functions. For example, in some aspects, two or more base station functions may be instantiated on a single device. In some aspects, the terms “base station,” “network entity,” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and receive, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations. Additionally, or alternatively, the communication manager 140 may perform one or more other operations described herein.

In some aspects, a network entity (e.g., a network node 110) may include a communication manager 150. As described in more detail elsewhere herein, the communication manager 150 may transmit PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and transmit, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations. Additionally, or alternatively, the communication manager 150 may perform one or more other operations described herein.

As indicated above, FIG. 1 is provided as an example. Other examples may differ from what is described with regard to FIG. 1.

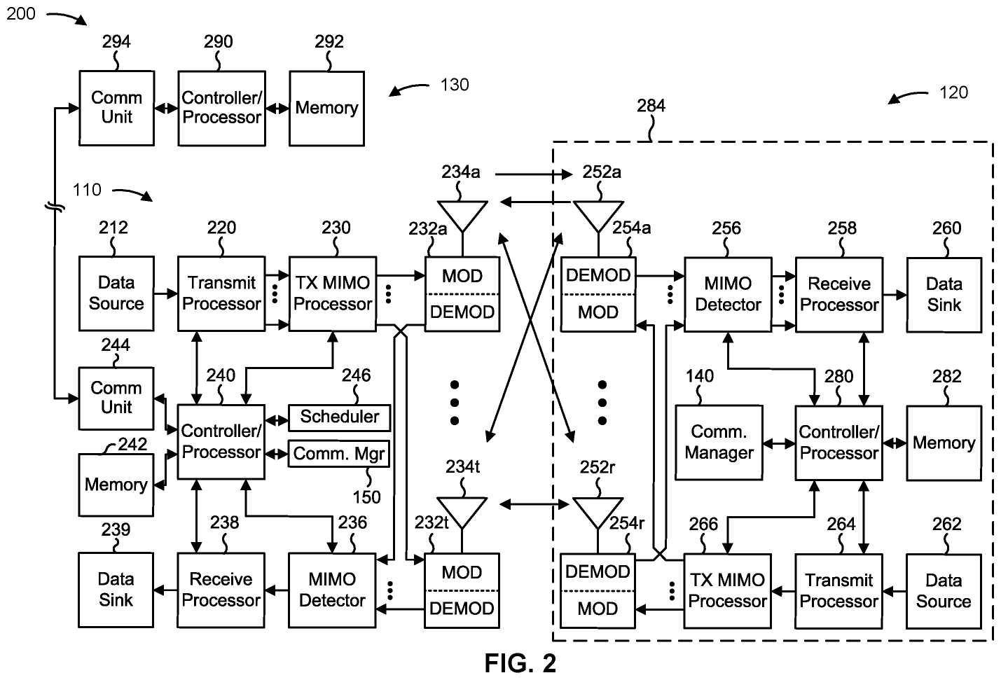

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

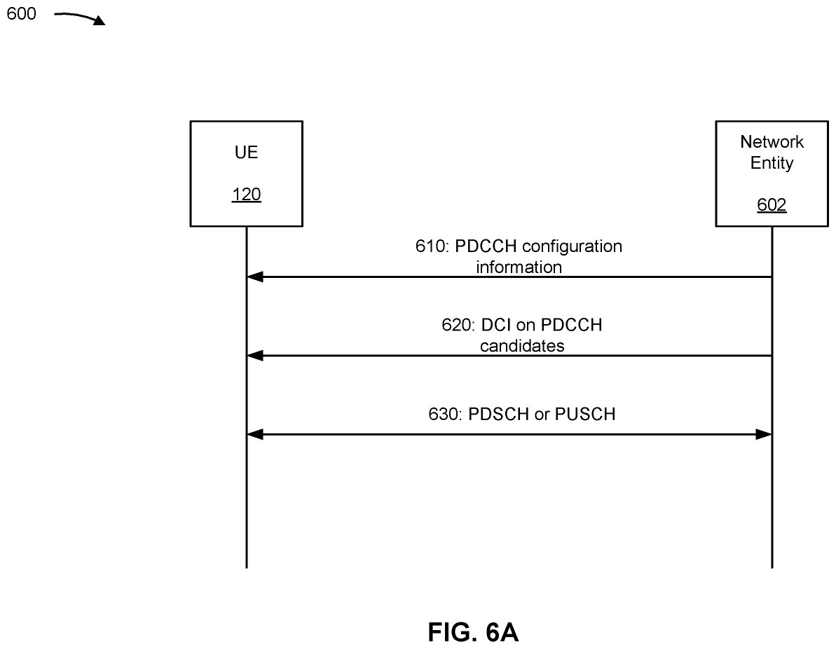

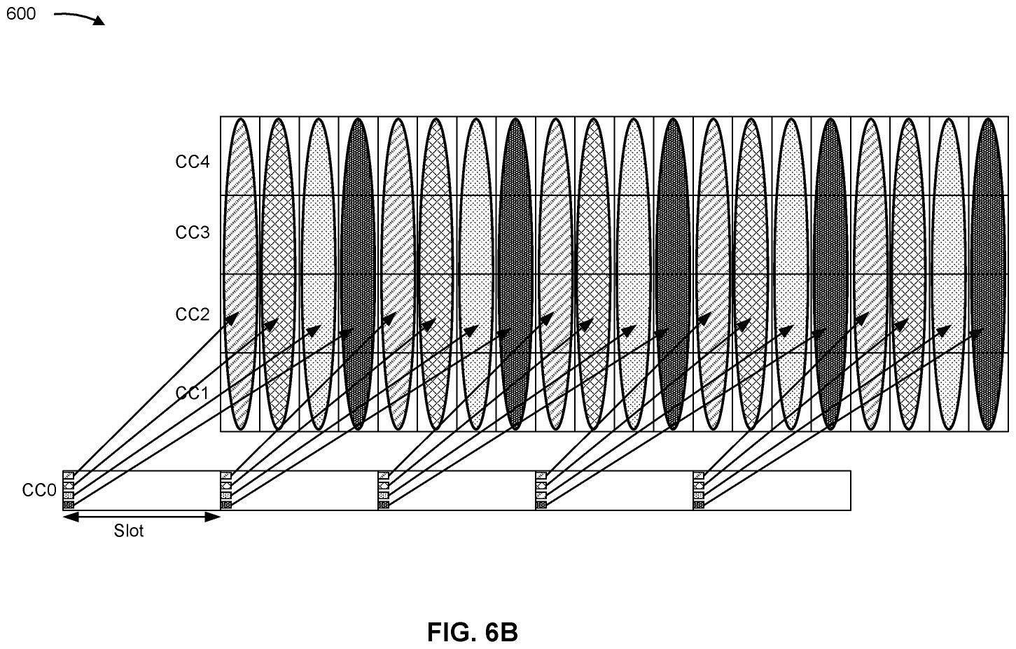

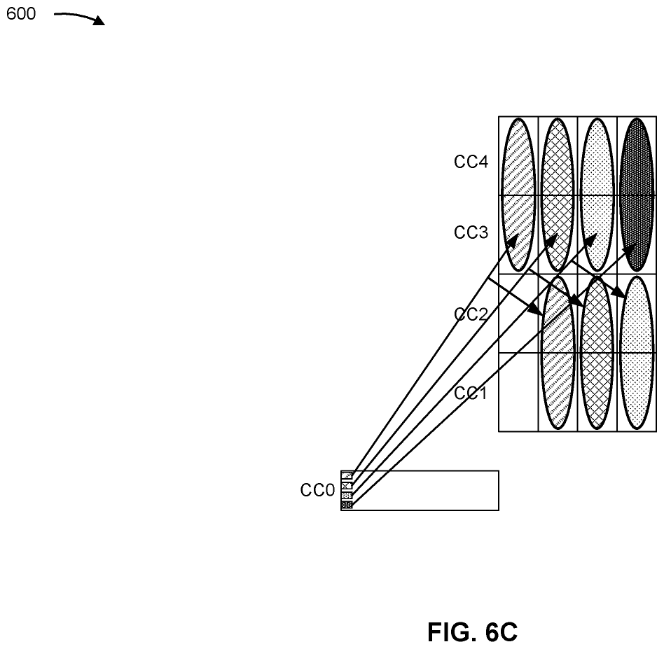

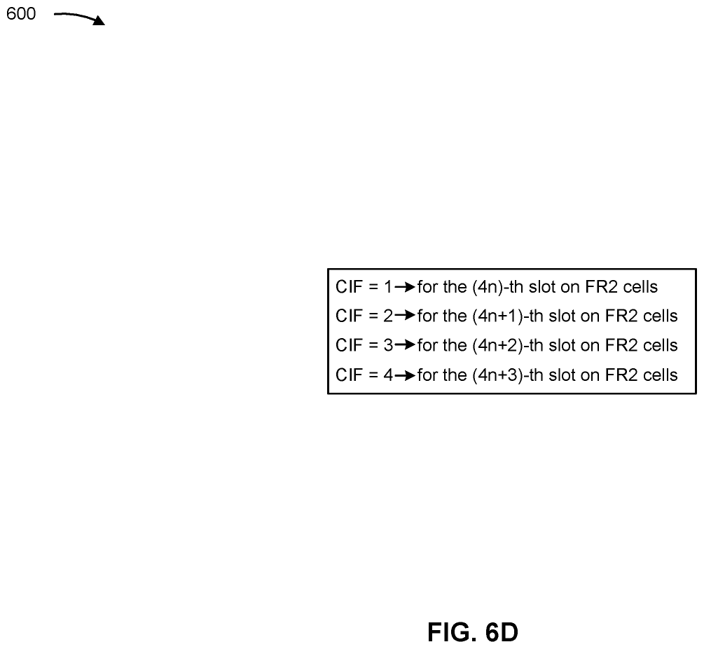

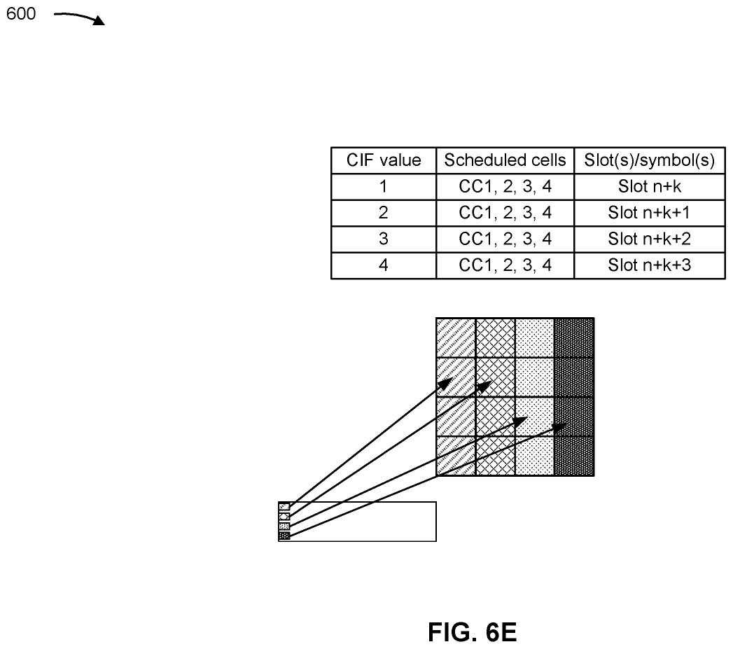

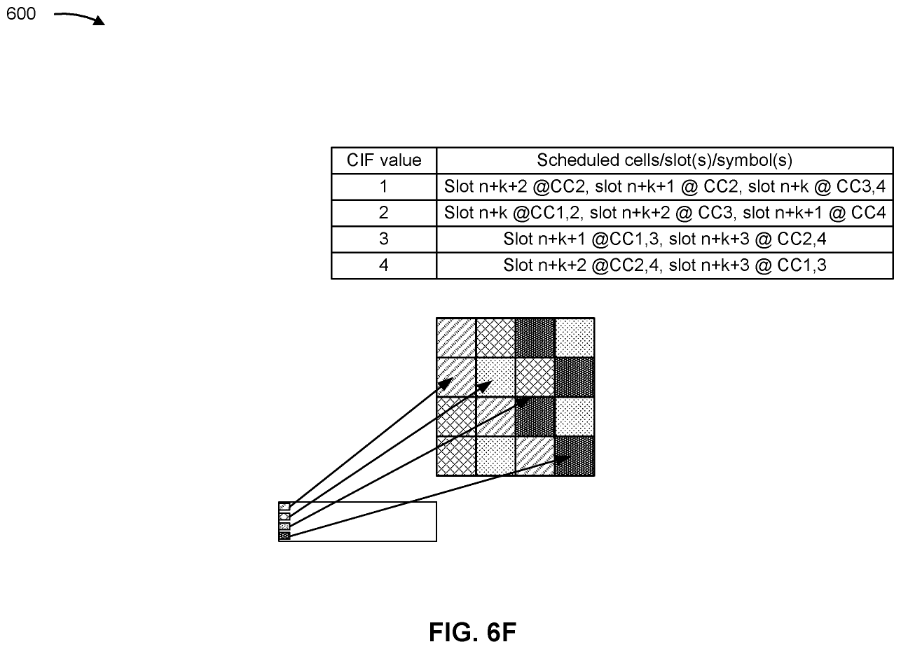

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6A-10).

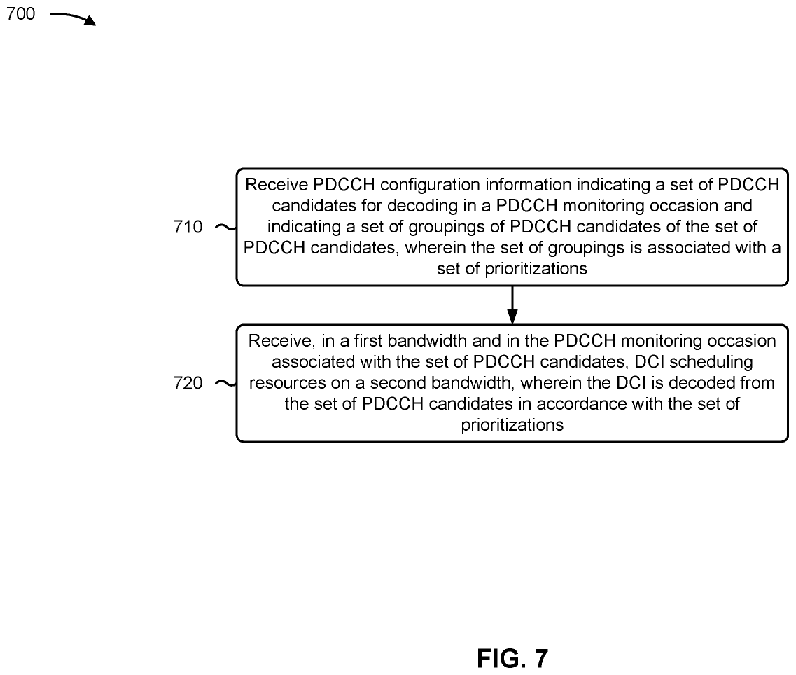

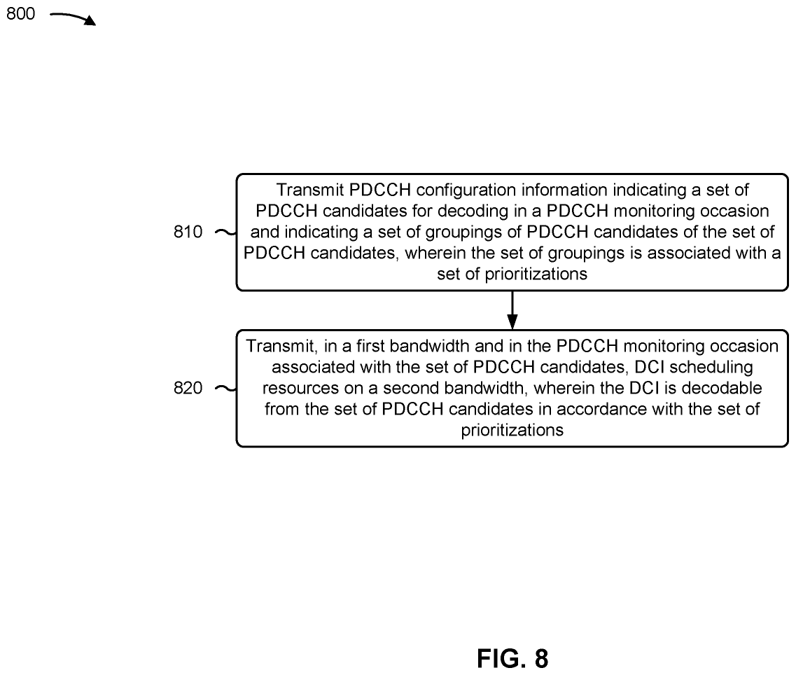

The controller/processor 240 of the network node 110, the controller/processor 280 of the UE 120, and/or any other component(s) of FIG. 2 may perform one or more techniques associated with PDCCH partitioning for multi-cell multi-slot scheduling, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for receiving PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and/or means for receiving, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the network node 110) includes means for transmitting PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and/or means for transmitting, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

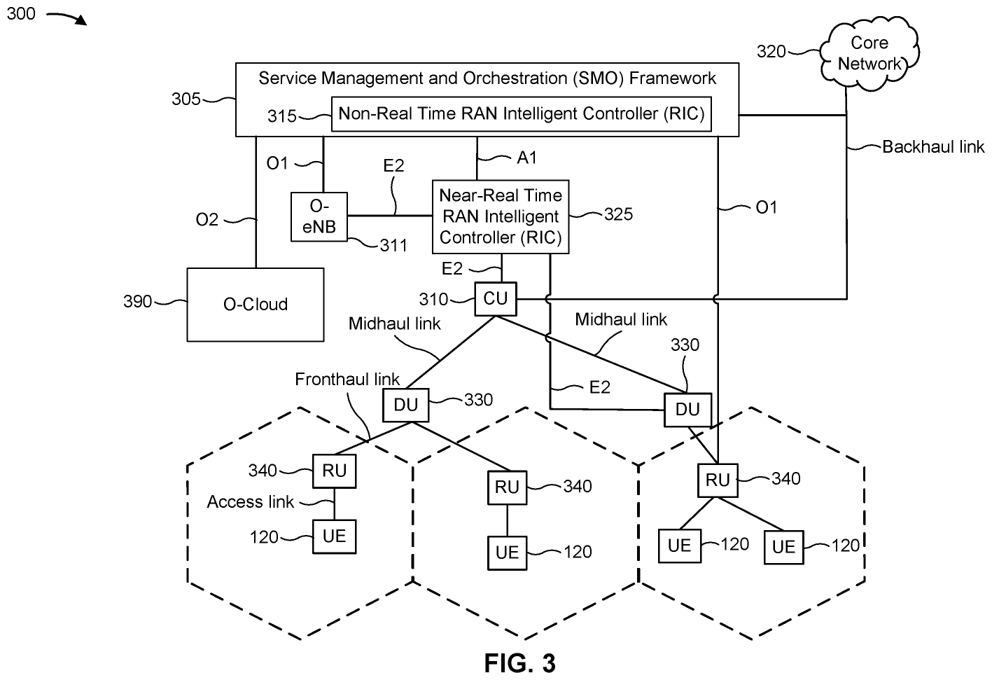

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

In some aspects, the DUs 330 and the RUs 340 may be implemented according to a functional split architecture in which functionality of a network node 110 (e.g., an eNB or a gNB) is provided by a DU 330 and one or more RUs 340 that communicate over a fronthaul link. Accordingly, as described herein, a network node 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

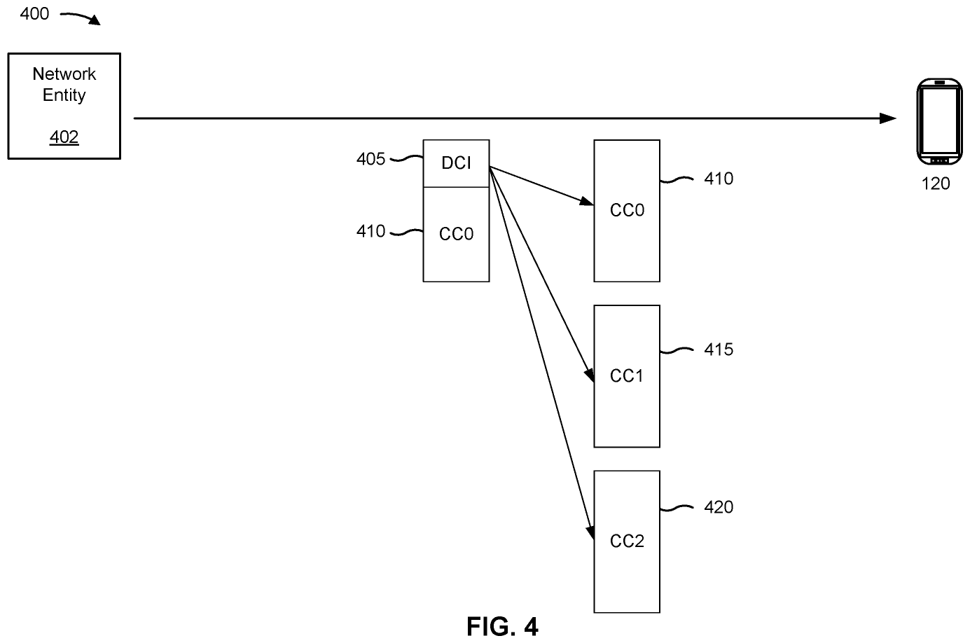

FIG. 4 is a diagram illustrating an example 400 of DCI that schedules multiple cells, in accordance with the present disclosure. As shown in FIG. 4, a network entity 402, which may correspond to the network node 110, and a UE 120 may communicate with one another.

The network entity 402 may transmit, to the UE 120, DCI 405 that schedules multiple communications for the UE 120. The multiple communications may be scheduled for at least two different cells. In some cases, a cell may be referred to as a component carrier (CC). In some cases, DCI that schedules a communication for a cell via which the DCI is transmitted may be referred to as self-carrier (or self-cell) scheduling DCI. In some cases, DCI that schedules a communication for a cell via which the DCI is transmitted may be referred to as cross-carrier (or cross-cell) scheduling DCI. The DCI 405 may be cross-carrier scheduling DCI, and may or may not be self-carrier scheduling DCI. The DCI 405 that carries communications in at least two cells may be referred to as combination DCI.

In example 400, the DCI 405 schedules a communication for a first cell 410 that carries the DCI 405 (shown as CC0), schedules a communication for a second cell 415 that does not carry the DCI 405 (shown as CC1), and schedules a communication for a third cell 420 that does not carry the DCI 405 (shown as CC2). The DCI 405 may schedule communications on a different number of cells than shown in FIG. 4 (e.g., two cells, four cells, five cells, and so on). The number of cells may be greater than or equal to two.

A communication scheduled by the DCI 405 may include a data communication, such as a physical downlink shared channel (PDSCH) communication or a physical uplink shared channel (PUSCH) communication. For a data communication, the DCI 405 may schedule a single transport block (TB) across multiple cells or may separately schedule multiple TBs in the multiple cells. Additionally, or alternatively, a communication scheduled by the DCI 405 may include a reference signal, such as a channel state information reference signal (CSI-RS) or a sounding reference signal (SRS). For a reference signal, the DCI 405 may trigger a single resource for reference signal transmission across multiple cells or may separately schedule multiple resources for reference signal transmission in the multiple cells. In some cases, scheduling information in the DCI 405 may be indicated once and reused for multiple communications (e.g., on different cells), such as a modulation and coding scheme (MCS), a resource to be used for acknowledgement (ACK) or negative acknowledgement (NACK) of a communication scheduled by the DCI 405, and/or a resource allocation for a scheduled communication, to conserve signaling overhead.

As indicated above, FIG. 4 is provided as an example. Other examples may differ from what is described with respect to FIG. 4.

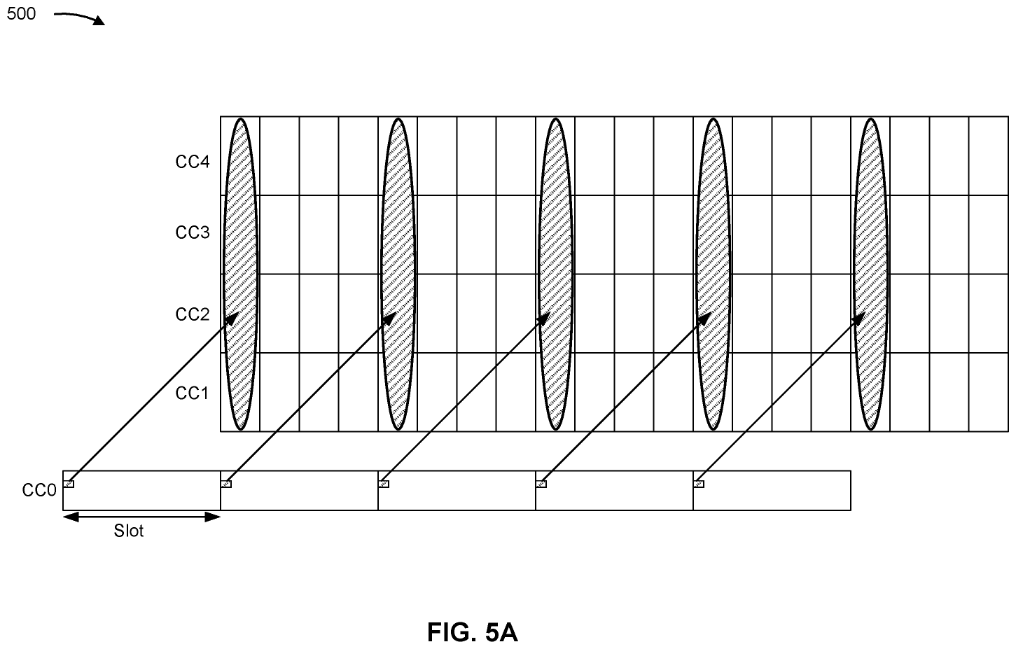

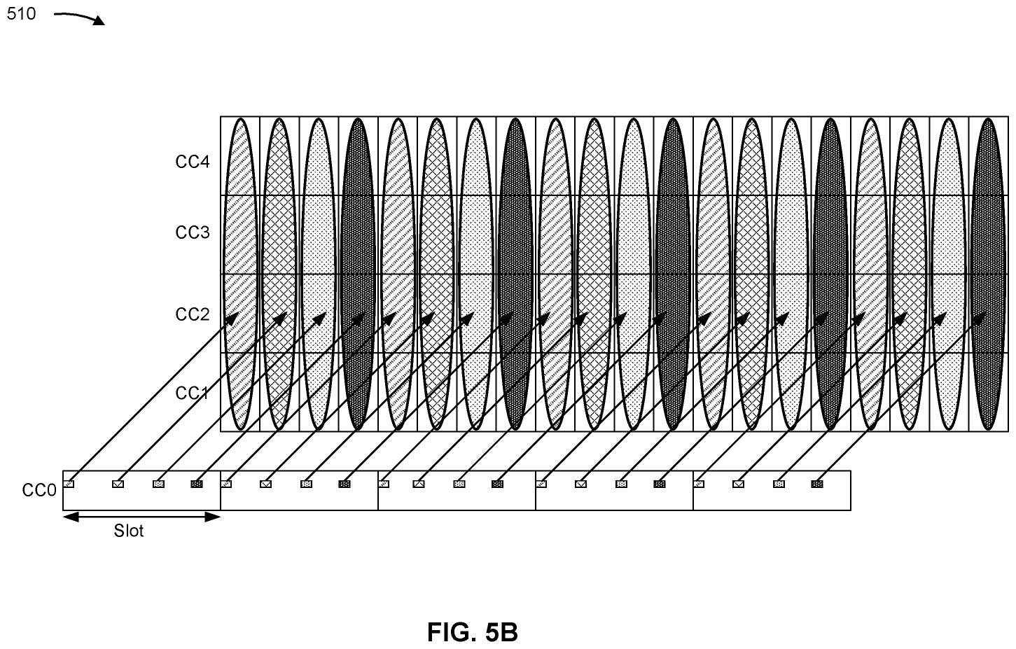

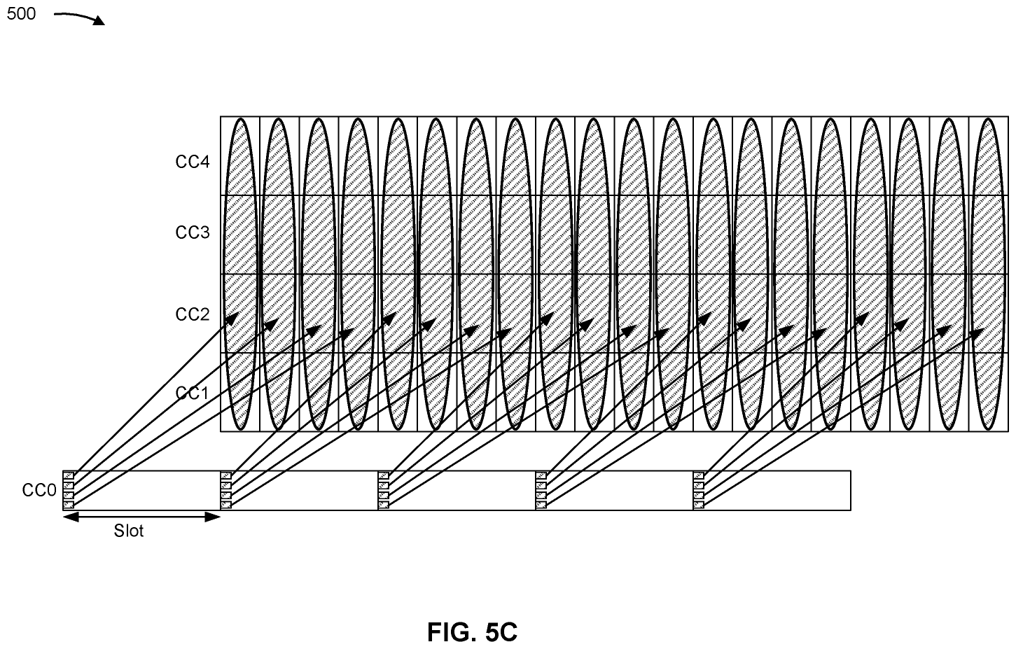

FIGS. 5A-5C are diagrams illustrating examples 500/510/520 of DCI that schedules multiple cells, in accordance with the present disclosure. As shown in FIGS. 5A-5C, a first bandwidth, such as one or more carriers in FR1, may be associated with a first carrier (CC0) and a second bandwidth, such as one or more carriers in FR2, may be associated with a set of second carriers (CC1, CC2, CC3, and CC4). Additionally, as shown, the carriers may be associated with different subcarrier spacings (SCSs). As an example, CC0 may be associated with an SCS of 30 kilohertz (kHz) and CC1-CC4 may be associated with an SCS of 120 kHz.

As shown in FIG. 5A, and by example 500, multi-cell scheduling may have a shared channel (e.g., a physical downlink shared channel (PDSCH) or a physical uplink shared channel PUSCH) in each cell. For example, a UE may monitor for a single DCI in each slot of a first carrier (CC0) and may receive scheduling for a set of shared channels across a set of carriers (CC1, CC2, CC3, and CC4). In this case, based at least in part on there being a PDCCH in each slot on CC0, and the DCI in the PDCCH scheduling a PDSCH or PUSCH for a set of cells, full scheduling (of all available resources on FR2) is not achieved.

In contrast, as shown in FIG. 5B, and by example 510, when there is a plurality of PDCCH monitoring occasions (MOs) in each slot of an FR1 cell (CC0), the plurality of MOs can support a UE receiving a plurality of DCI messages scheduling a corresponding plurality of PDSCHs or PUSCHs on FR2 cells (CC1-CC4). In this case, based at least in part on there being a plurality of PDCCHs in each slot on CC0, full scheduling (of all available resources on 1-R2) is achieved. Similarly, as shown in FIG. 5C, and by example 520, rather than multiple PDCCH MOs in each slot on CC0, a network entity may transmit a plurality of DCI messages in a single PDCCH MO of each slot on CC0. In this case, a first DCI in the single PDCCH MO may schedule a PDSCH or PUSCH on a first slot of FR2, a second DCI in the single PDCCH MO may schedule a PDSCH or PUSCH on a second slot of FR2, a third DCI in the single PDCCH MO may schedule a PDSCH or PUSCH on a third slot of FR2, and a fourth DCI in the single PDCCH MO may schedule a PDSCH or PUSCH on a fourth slot of FR2. In this way, based at least in part on having a plurality of DCI messages in each PDCCH MO, full scheduling (of all available resources on FR2) is achieved. Although some aspects are described herein in terms of a 4:1 SCS ratio between FR2 and FR1, other ratios of slots, arrangements of bandwidths, or quantities of PDCCH MOs or DCIs are contemplated.

As indicated above, FIGS. 5A-5C is provided as an example. Other examples may differ from what is described with respect to FIGS. 5A-5C.

As described above, to achieve full scheduling of resources on FR2, using DCI transmitted on FR1, a network entity may transmit DCI using a plurality of PDCCH MOs in each slot on a scheduling cell of FR1. In this case, at each PDCCH MO, there may be N PDCCH candidates for a UE to blind decode and the UE may detect up to n (e.g., 1 or 2) DCIs per MO (where n≤N). However, to blind decode the N PDCCH candidates (e.g., to receive n DCIs), the UE may have to remain in an active state on the scheduling cell, which may prevent the UE from entering a reduced power state (e.g., a sleep state) on the scheduling cell.

Thus, to reduce a power consumption, rather than a plurality of PDCCH MOs in each slot, the network entity may transmit a plurality of DCI in a single PDCCH MO of each slot. For example, there may be N×M PDCCH candidates for blind decoding in a PDCCH MO, and the UE may detect up to n×m DCIs (where n≤N, m≤M, and where M represents a quantity of shared channels over a set of scheduled cells for which the PDCCH MO is to convey scheduling information). However, as was shown with respect to FIG. 5C, in the set of PDCCH candidates, the UE does not know on which n×m PDCCH candidates out from N×M DCIs are mapped. Accordingly, the UE is not able to prioritize between PDCCH decodes. As a result, the UE may decode PDCCH candidates out of order with respect to when the PDCCH candidates schedule data. In this case, the UE may decode last a PDCCH candidate that schedules data first, which may result in the UE not having enough time to configure a receiver for receiving the data.

Some aspects described herein enable partitioning of the set of PDCCH candidates for multi-cell multi-slot scheduling before decoding the PDCCH candidates. For example, a network entity may configure a UE with X PDCCH candidates that are partitioned into Y subsets, and each subset may be associated with a prioritization. In this case, the UE may decode PDCCH candidates in an order associated with the prioritization of the partitions to which the PDCCH candidates are divided. The prioritization may be a time order of data scheduled by the DCIs. As a result, the UE may decode a subset of PDCCH candidates that may be associated with earlier scheduled resources than other PDCCH candidates (e.g., scheduled resources to be transmitted or received or that are associated with HARQ-ACK feedback at an earlier timing than other resources associated with other subsets of PDCCH candidates). Accordingly, the network entity and the UE ensure that there is adequate time to configure a receiver for receiving data scheduled by the DCI in the PDCCH candidates. In this way, the network entity and the UE improve communication performance by reducing a likelihood of dropped communications and enable the UE to transition to a power saving mode during a remainder of a slot after receipt of the PDCCH candidates.

FIGS. 6A-6F are diagrams illustrating an example 600 associated with PDCCH partitioning for multi-cell multi-slot scheduling, in accordance with the present disclosure. As shown in FIG. 6A, example 600 includes communication between a network entity 602, which may correspond to the network node 110, and a UE 120.

As further shown in FIG. 6A, and by reference number 610, the UE 120 may receive, from the network entity 602, PDCCH configuration information. For example, the UE 120 may receive information identifying a set of PDCCH candidates for the UE 120 to decode in a PDCCH monitoring occasion. Additionally, or alternatively, the UE 120 may receive information indicating a set of groupings or partitions of the PDCCH candidates. For example, the UE 120 may receive information identifying a set of X PDCCH candidates that are partitioned into Y subsets (e.g., the groupings or partitions). In this case, each subset of the set of X candidates may have floor(X/Y) candidates or floor(X/Y)+1 candidates. For example, as shown in FIG. 6B, when there are 4 PDCCH candidates in each slot and 4 subsets, each subset may have 1 PDCCH candidate scheduling onto a set of carriers of a respective slot in the second bandwidth. In this case, a first subset schedules onto a first slot, a second subset schedules onto a second slot, a third subset schedules onto a third slot, and a fourth subset schedules onto a fourth slot.

In some aspects, the UE 120 may receive radio resource control (RRC) signaling conveying the PDCCH configuration information identifying a quantity of groupings or partitions and/or an assignment of PDCCH candidates to groupings or partitions. In some aspects, the UE 120 may receive PDCCH configuration information indicating which slot or symbol a subset of PDCCH candidates can have downlink control information (DCI) scheduling data communications (e.g., a PDSCH or a PUSCH). For example, the UE 120 may receive information that a first subset can have DCI scheduling one or more PDSCHs or PUSCHs) on a slot n+k and a second subset can have DCI scheduling one or more PDSCHs or PUSCHs on a slot n+k+1. Alternatively, the UE 120 may receive information that a first subset can have DCI scheduling a PDSCHs associated with HARQ-ACK feedback on a slot n+k and a second subset can have DCI scheduling a PDSCHs that are associated with HARQ-ACK feedback on a slot n+k+1.

In some aspects, the UE 120 may determine a prioritization of the groupings or partitions for PDCCH blind decode. This may be based at least in part on the information identifying the slot or symbol that a DCI can schedule. For example, the UE 120 may prioritize PDCCH candidates in an order of slots that DCI in the PDCCH candidates schedule. Returning to the above example, the UE 120 may prioritize the first subset over the second subset, as the first subset schedules on a slot n+k that occurs before a slot n+k+1 scheduled by the second subset. In this way, the UE 120 reduces a likelihood that delays in decoding DCI in the PDCCH candidates prevent the UE 120 from transmitting or receiving on a cell scheduled by the PDCCH candidates.

As further shown in FIG. 6A, and by reference numbers 620 and 630, the UE 120 may receive DCI on a set of PDCCH candidates of a first bandwidth and may communicate with the network entity 602 (e.g., transmit a PDSCH or receive a PUSCH) on a second bandwidth. For example, the UE 120 may receive, on a cell of the first bandwidth DCI scheduling communications (e.g., PDSCH communications or PUSCH communications) on a set of cells of the second bandwidth. As shown in FIG. 6B, each slot on CC0 may include PDCCH candidates for scheduling on CC1-CC4 in a corresponding slot. For example, each first PDCCH candidate of a slot of CC0 may schedule in a corresponding slot on CC1-CC4, each second PDCCH candidate of a slot of CC0 may schedule in a corresponding slot on CC1-CC4, each third PDCCH candidate of a slot of CC0 may schedule in a corresponding slot on CC1-CC4, and each fourth PDCCH candidate of a slot of CC0 may schedule in a corresponding slot on CC1-CC4.

In some aspects, DCI received by the UE 120 in a PDCCH candidate may schedule data on multiple cells and across multiple slots. For example, as shown in FIG. 6C, the UE 120 may receive DCI in a first PDCCH candidate that schedules on CC3 and CC4 in a first slot and that schedules on CC1 and CC2 in a second slot. Similarly, the UE 120 may receive DCI in a second PDCCH candidate that schedules on CC3 and CC4 in a second slot and CC1 and CC2 in a third slot; the UE 120 may receive DCI in a third PDCCH candidate that schedules on CC3 and CC4 in a third slot and CC1 and CC2 in a fourth slot; and the UE 120 may receive DCI in a fourth PDCCH candidate that schedules on CC3 and CC4 in a fourth slot and does not schedule on CC1 and CC2.

In some aspects, the UE 120 may use a parameter value, such as a carrier indicator field (CIF) value, to map a scheduling cell to a subset of PDCCH candidates on a scheduled cell. The UE may identify a set of control channel elements (CCEs) for PDCCH candidates associated with different nu values before PDCCH blind decodes, where an n_{C1} value and a CIF value are associated with a one-to-one mapping (e.g., an nu value is equal to a corresponding CIF value). Therefore, if different CIF values are associated with DCIs that schedule data on different slots or that are associated with HARQ-ACK feedback on different slots, the UE may be able to determine the decoding priorities for a set of PDCCH candidates associated with different CIF (or n_{C1}) values. For example, as shown in FIG. 6D, when the UE 120 receives, in DCI, a first CIF value (‘1’), the UE 120 may determine that the DCI schedules for a (4n)-th slot on the scheduled cells (e.g., CC1-CC4). Similarly, the UE 120 may interpret a second CIF value (‘2’) to indicate scheduling on a (4n+1)-th slot, a third CIF value (‘3’) to indicate scheduling on a (4n+2)-th slot, and a fourth CIF value (‘4’) to indicate scheduling on a (4n+3)-th slot. Similarly, the UE 120 may be configured (e.g., by the network entity 602 via RRC signaling) with a plurality of CIF values corresponding to a set of N cells that can be scheduled from a scheduling cell. For example, as shown in FIG. 6E, a first CIF value may indicate scheduling on CC1-CC4 for slot n+k, a second CIF value may indicate scheduling on CC1-CC4 for a slot n+k+1, a third CIF value may indicate scheduling on CC1-CC4 for a slot n+k+2, and a fourth CIF value may indicate scheduling on CC1-CC4 for a slot n+k+3. In this case, the UE 120 may decode DCI in order of CIF value, as the CIF values are ordered sequentially with respect to the scheduled slots. In some aspects, each CIF value may indicate different combinations of carriers and slots. For example, as shown in FIG. 6F, a first CIF value may indicate scheduling in slot n+k+2 on CC1, in slot n+k+1 on CC2, and in slot n+k on CC3 and CC4. In contrast, as shown in FIG. 6F, a second CIF value may indicate scheduling in slot n+k on CC1 and CC2, in slot n+k+2 on CC3, and in slot n+k+1 on CC4. In this case, the UE 120 may decode CIFs 1 and 2 before CIFs 3 and 4 as CIFs 1 and 2 include scheduling on slots n+k, and CIFs 3 and 4 only include scheduling on slots after slots n+k.

As indicated above, FIGS. 6A-6F are provided as examples. Other examples may differ from what is described with respect to FIGS. 6A-6F.

FIG. 7 is a diagram illustrating an example process 700 performed, for example, by a UE, in accordance with the present disclosure. Example process 700 is an example where the UE (e.g., UE 120) performs operations associated with PDCCH partitioning for multi-cell multi-slot scheduling.

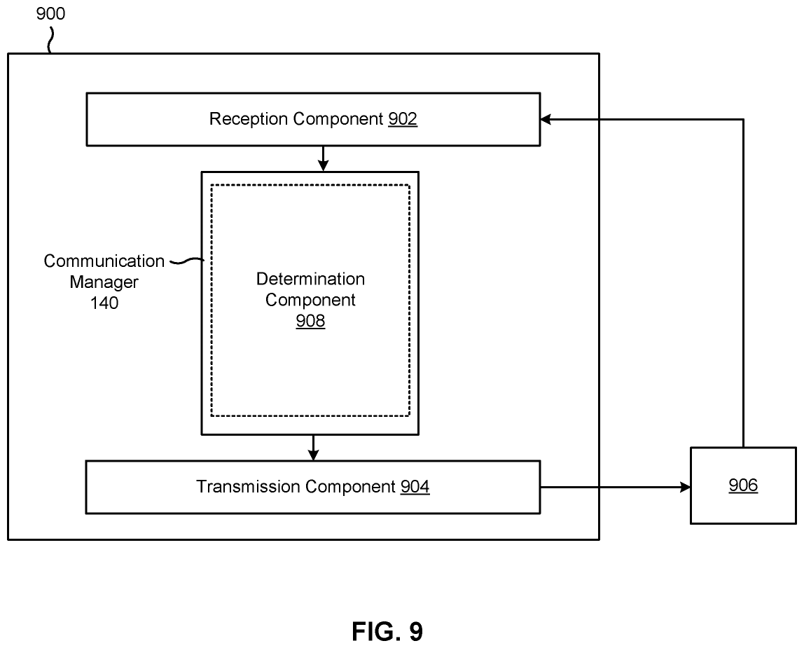

As shown in FIG. 7, in some aspects, process 700 may include receiving PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations (block 710). For example, the UE (e.g., using communication manager 140 and/or reception component 902, depicted in FIG. 9) may receive PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations, as described above.

As further shown in FIG. 7, in some aspects, process 700 may include receiving, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations (block 720). For example, the UE (e.g., using communication manager 140 and/or reception component 902, depicted in FIG. 9) may receive, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations, as described above.

Process 700 may include additional aspects, such as any single aspect or any combination of aspects described below and/or in connection with one or more other processes described elsewhere herein.

In a first aspect, process 700 includes receiving, in the second bandwidth, data communications scheduled by the DCI.

In a second aspect, alone or in combination with the first aspect, process 700 includes determining, based at least in part on the DCI, the resources on the second bandwidth on which to receive the data communications, and receiving the data communications comprises receiving the data communications based at least in part on determining the resources on the second bandwidth on which to receive the data communications.

In a third aspect, alone or in combination with one or more of the first and second aspects, process 700 includes determining, based at least in part on the PDCCH configuration information, the set of PDCCH candidates in which to receive the DCI, and receiving the DCI comprises receiving the DCI based at least in part on determining the set of PDCCH candidates in which to receive the DCI.

In a fourth aspect, alone or in combination with one or more of the first through third aspects, the first bandwidth includes one or more carriers in FR1 and the second bandwidth includes one or more carriers in FR2.

In a fifth aspect, alone or in combination with one or more of the first through fourth aspects, the first bandwidth is associated with a first cell and the second bandwidth is associated with a plurality of second cells.

In a sixth aspect, alone or in combination with one or more of the first through fifth aspects, the first bandwidth is associated with a first subcarrier spacing and the second bandwidth is associated with a second subcarrier spacing that is smaller than the first subcarrier spacing.

In a seventh aspect, alone or in combination with one or more of the first through sixth aspects, the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

In an eighth aspect, alone or in combination with one or more of the first through seventh aspects, the DCI includes a parameter value identifying a set of slots of a set of scheduled cells that are scheduled from the scheduling cell on which the DCI is received.

In a ninth aspect, alone or in combination with one or more of the first through eighth aspects, the DCI includes a parameter value that maps to a common slot or symbol for a set of scheduled cells.

In a tenth aspect, alone or in combination with one or more of the first through ninth aspects, the DCI includes a CIF value that maps to a set of scheduled cells, and the parameter value maps to a first slot or symbol for a first cell, of the set of scheduled cells, and maps to a second slot or symbol, that is different from the first slot or symbol, for a second cell of the set of scheduled cells.

In an eleventh aspect, alone or in combination with one or more of the first through tenth aspects, process 700 includes tuning to the second bandwidth to communicate on the second bandwidth using the resources.

In a twelfth aspect, alone or in combination with one or more of the first through eleventh aspects, process 700 includes transmitting one or more communications on the second bandwidth using at least a portion of the resources.

In a thirteenth aspect, alone or in combination with one or more of the first through twelfth aspects, process 700 includes receiving or more communications on the second bandwidth using at least a portion of the resources.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., network node 110, CU 310, DU 330, RU 340, network entity 402, or network entity 602, among other examples) performs operations associated with PDCCH partitioning for multi-cell multi-slot scheduling.

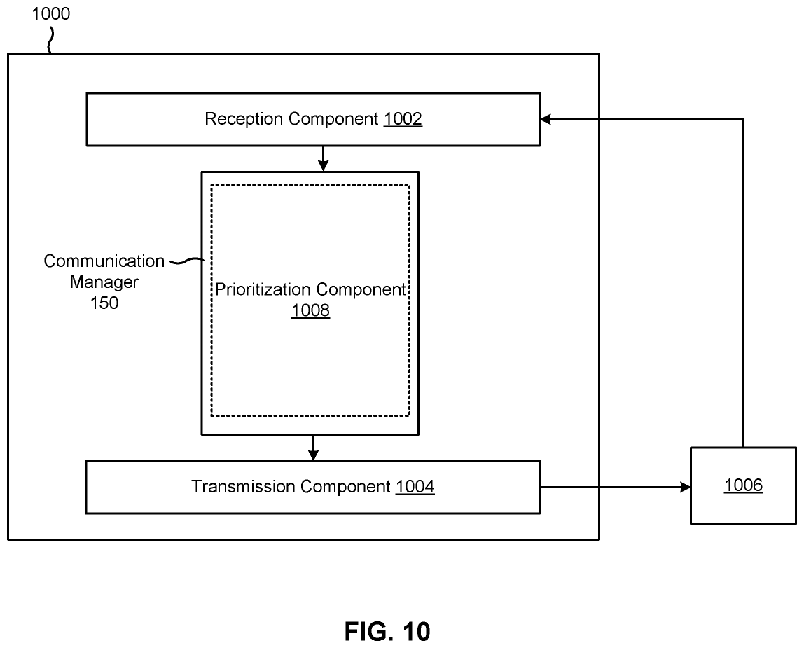

As shown in FIG. 8, in some aspects, process 800 may include transmitting PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations (block 810). For example, the network entity (e.g., using communication manager 150 and/or transmission component 1004, depicted in FIG. 10) may transmit PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations, as described above.

As further shown in FIG. 8, in some aspects, process 800 may include transmitting, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations (block 820). For example, the network entity (e.g., using communication manager 150 and/or transmission component 1004, depicted in FIG. 1004) may transmit, in a first bandwidth and in the PDCCH monitoring occasion associated with the set of PDCCH candidates, downlink control information (DCI) scheduling resources on a second bandwidth, wherein the DCI is decodable from the set of PDCCH candidates in accordance with the set of prioritizations, as described above.

Process 800 may include additional aspects, such as any single aspect or any combination of aspects described below and/or in connection with one or more other processes described elsewhere herein.

In a first aspect, process 800 includes transmitting, in the second bandwidth, data communications scheduled by the DCI.

In a second aspect, alone or in combination with the first aspect, the first bandwidth includes one or more carriers in FR1 and the second bandwidth includes one or more carriers in FR2.

In a third aspect, alone or in combination with one or more of the first and second aspects, the first bandwidth is associated with a first cell and the second bandwidth is associated with a plurality of second cells.

In a fourth aspect, alone or in combination with one or more of the first through third aspects, the first bandwidth is associated with a first subcarrier spacing and the second bandwidth is associated with a second subcarrier spacing that is smaller than the first subcarrier spacing.

In a fifth aspect, alone or in combination with one or more of the first through fourth aspects, the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

In a sixth aspect, alone or in combination with one or more of the first through fifth aspects, the DCI includes a parameter value identifying a set of slots of a set of scheduled cells that are scheduled from the scheduling cell on which the DCI is received.

In a seventh aspect, alone or in combination with one or more of the first through sixth aspects, the DCI includes a parameter value that maps to a common slot or symbol for a set of scheduled cells.

In an eighth aspect, alone or in combination with one or more of the first through seventh aspects, the DCI includes a CIF value that maps to a set of scheduled cells, and the parameter value maps to a first slot or symbol for a first cell, of the set of scheduled cells, and maps to a second slot or symbol, that is different from the first slot or symbol, for a second cell of the set of scheduled cells.

In a ninth aspect, alone or in combination with one or more of the first through eighth aspects, process 800 includes tuning to the second bandwidth to communicate on the second bandwidth using the resources.

In a tenth aspect, alone or in combination with one or more of the first through ninth aspects, process 800 includes transmitting one or more communications on the second bandwidth using at least a portion of the resources.

In an eleventh aspect, alone or in combination with one or more of the first through tenth aspects, process 800 includes receiving or more communications on the second bandwidth using at least a portion of the resources.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a network node, or another wireless communication device) using the reception component 902 and the transmission component 904. As further shown, the apparatus 900 may include the communication manager 140. The communication manager 140 may include a determination component 908, among other examples.

In some aspects, the apparatus 900 may be configured to perform one or more operations described herein in connection with FIGS. 6A-6F. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The reception component 902 may receive, in a first bandwidth and in the PDCCH monitoring occasion associated with the set of PDCCH candidates, DCI scheduling resources on a second bandwidth, wherein the DCI is decoded from the set of PDCCH candidates in accordance with the set of prioritizations.

The reception component 902 may receive, in the second bandwidth, data communications scheduled by the DCI. The determination component 908 may determine, based at least in part on the DCI, the resources on the second bandwidth on which to receive the data communications. The determination component 908 may determine, based at least in part on the PDCCH configuration information, the set of PDCCH candidates in which to receive the DCI.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include the communication manager 150. The communication manager 150 may include a prioritization component 1008, among other examples.

In some aspects, the apparatus 1000 may be configured to perform one or more operations described herein in connection with FIGS. 6A-6F. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The transmission component 1004 may transmit PDCCH configuration information indicating a set of PDCCH candidates for decoding in a PDCCH monitoring occasion and indicating a set of groupings of PDCCH candidates of the set of PDCCH candidates, wherein the set of groupings is associated with a set of prioritizations. The transmission component 1004 may transmit, in a first bandwidth and in the PDCCH monitoring occasion associated with the set of PDCCH candidates, DCI scheduling resources on a second bandwidth, wherein the DCI is decodable from the set of PDCCH candidates in accordance with the set of prioritizations. The transmission component 1004 may transmit, in the second bandwidth, data communications scheduled by the DCI. The prioritization component 1008 may determine the set of prioritizations for the set of groupings of PDCCH candidates.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and receiving, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations.

Aspect 2: The method of Aspect 1, further comprising: receiving, in the second bandwidth, data communications scheduled by the DCI.

Aspect 3: The method of any of Aspects 1 to 2, further comprising: determining, based at least in part on the DCI, the resources on the second bandwidth on which to receive the data communications; and wherein receiving the data communications comprises: receiving the data communications based at least in part on determining the resources on the second bandwidth on which to receive the data communications.

Aspect 4: The method of any of Aspects 1 to 3, further comprising: determining, based at least in part on the PDCCH configuration information, the set of PDCCH candidates in which to receive the DCI; and wherein receiving the DCI comprises: receiving the DCI based at least in part on determining the set of PDCCH candidates in which to receive the DCI. wherein receiving the DCI comprises: receiving the DCI based at least in part on determining the set of PDCCH candidates in which to receive the DCI.

Aspect 5: The method of any of Aspects 1 to 4, wherein the first bandwidth includes one or more carriers in frequency range 1 (1-R1) and the second bandwidth includes one or more carriers in frequency range 2 (1-R2).

Aspect 6: The method of any of Aspects 1 to 5, wherein the first bandwidth is associated with a first cell and the second bandwidth is associated with a plurality of second cells.

Aspect 7: The method of any of Aspects 1 to 6, wherein the first bandwidth is associated with a first subcarrier spacing and the second bandwidth is associated with a second subcarrier spacing that is smaller than the first subcarrier spacing.

Aspect 8: The method of any of Aspects 1 to 7, wherein the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

Aspect 9: The method of any of Aspects 1 to 8, wherein the DCI includes a parameter value identifying a set of slots of a set of scheduled cells that are scheduled from the scheduling cell on which the DCI is received.

Aspect 10: The method of any of Aspects 1 to 9, wherein the DCI includes a parameter value that maps to a common slot or symbol for a set of scheduled cells.

Aspect 11: The method of any of Aspects 1 to 10, wherein the DCI includes a parameter value that maps to a set of scheduled cells, and wherein the parameter value maps to a first slot or symbol for a first cell, of the set of scheduled cells, and maps to a second slot or symbol, that is different from the first slot or symbol, for a second cell of the set of scheduled cells.

Aspect 12: The method of any of Aspects 1 to 11, further comprising: tuning to the second bandwidth to communicate on the second bandwidth using the resources.

Aspect 13: The method of any of Aspects 1 to 12, further comprising: transmitting one or more communications on the second bandwidth using at least a portion of the resources.

Aspect 14: The method of any of Aspects 1 to 13, further comprising: receiving or more communications on the second bandwidth using at least a portion of the resources.

Aspect 15: A method of wireless communication performed by a network entity, comprising: transmitting physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and transmitting, in a first bandwidth and in the PDCCH monitoring occasion associated with the set of PDCCH candidates, downlink control information (DCI) scheduling resources on a second bandwidth, wherein the DCI is decodable from the set of PDCCH candidates in accordance with the set of prioritizations.

Aspect 16: The method of Aspect 15, further comprising: transmitting, in the second bandwidth, data communications scheduled by the DCI.

Aspect 17: The method of any of Aspects 15 to 16, wherein the first bandwidth includes one or more carriers in frequency range 1 (FR1) and the second bandwidth includes one or more carriers in frequency range 2 (1-R2).

Aspect 18: The method of any of Aspects 15 to 17, wherein the first bandwidth is associated with a first cell and the second bandwidth is associated with a plurality of second cells.

Aspect 19: The method of any of Aspects 15 to 18, wherein the first bandwidth is associated with a first subcarrier spacing and the second bandwidth is associated with a second subcarrier spacing that is smaller than the first subcarrier spacing.

Aspect 20: The method of any of Aspects 15 to 19, wherein the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

Aspect 21: The method of any of Aspects 15 to 20, wherein the DCI includes a parameter value identifying a set of slots of a set of scheduled cells that are scheduled from the scheduling cell on which the DCI is received.

Aspect 22: The method of any of Aspects 15 to 21, wherein the DCI includes a parameter value that maps to a common slot or symbol for a set of scheduled cells.

Aspect 23: The method of any of Aspects 15 to 22, wherein the DCI includes a parameter value that maps to a set of scheduled cells, and wherein the parameter value maps to a first slot or symbol for a first cell, of the set of scheduled cells, and maps to a second slot or symbol, that is different from the first slot or symbol, for a second cell of the set of scheduled cells.

Aspect 24: The method of any of Aspects 15 to 23, further comprising: tuning to the second bandwidth to communicate on the second bandwidth using the resources.

Aspect 25: The method of any of Aspects 15 to 24, further comprising: transmitting one or more communications on the second bandwidth using at least a portion of the resources.

Aspect 26: The method of any of Aspects 15 to 25, further comprising: receiving or more communications on the second bandwidth using at least a portion of the resources.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 30: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and
receive, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations.

2. The UE of claim 1, wherein the one or more processors are further configured to:
tune to the second bandwidth to communicate on the second bandwidth using the resources.

3. The UE of claim 2, wherein the one or more processors are further configured to:
transmit one or more communications on the second bandwidth using at least a portion of the resources.

4. The UE of claim 2, wherein the one or more processors are further configured to:
receive or more communications on the second bandwidth using at least a portion of the resources.

5. The UE of claim 1, wherein the one or more processors are further configured to:
receive, in the second bandwidth, data communications scheduled by the DCI.

6. The UE of claim 5, wherein the one or more processors are further configured to:
determine, based at least in part on the DCI, the resources on the second bandwidth on which to receive the data communications; and
wherein the one or more processors, to receive the data communications, are configured to:
receive the data communications based at least in part on determining the resources on the second bandwidth on which to receive the data communications.

7. The UE of claim 1, wherein the one or more processors are further configured to:
determine, based at least in part on the PDCCH configuration information, the set of PDCCH candidates in which to receive the DCI; and
wherein the one or more processors, to receive the DCI, are configured to:
receive the DCI based at least in part on determining the set of PDCCH candidates in which to receive the DCI.

8. The UE of claim 1, wherein the first bandwidth includes one or more carriers in frequency range 1 (FR1) and the second bandwidth includes one or more carriers frequency range 2 (FR2).

9. The UE of claim 1, wherein the first bandwidth is associated with a first cell and the second bandwidth is associated with a plurality of second cells.

10. The UE of claim 1, wherein the first bandwidth is associated with a first subcarrier spacing and the second bandwidth is associated with a second subcarrier spacing that is smaller than the first subcarrier spacing.

11. The UE of claim 1, wherein the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

12. The UE of claim 1, wherein the DCI includes a parameter value identifying a set of slots of a set of scheduled cells that are scheduled from a scheduling cell on which the DCI is received.

13. The UE of claim 1, wherein the DCI includes a parameter value that maps to a common slot or symbol for a set of scheduled cells.

14. The UE of claim 1, wherein the DCI includes a parameter value that maps to a set of scheduled cells, and wherein the parameter value maps to a first slot or symbol for a first cell, of the set of scheduled cells, and maps to a second slot or symbol, that is different from the first slot or symbol, for a second cell of the set of scheduled cells.

15. A network entity for wireless communication, comprising:
a memory; and
one or more processors, coupled to the memory, configured to:
transmit physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and
transmit, in a first bandwidth and in the PDCCH monitoring occasion associated with the set of PDCCH candidates, downlink control information (DCI) scheduling resources on a second bandwidth, wherein the DCI is decodable from the set of PDCCH candidates in accordance with the set of prioritizations.

16. The network entity of claim 15, wherein the one or more processors are further configured to:
tune to the second bandwidth to communicate on the second bandwidth using the resources.

17. The network entity of claim 16, wherein the one or more processors are further configured to:
transmit one or more communications on the second bandwidth using at least a portion of the resources.

18. The network entity of claim 16, wherein the one or more processors are further configured to:
receive or more communications on the second bandwidth using at least a portion of the resources.

19. The network entity of claim 15, wherein the one or more processors are further configured to:
transmit, in the second bandwidth, data communications scheduled by the DCI.

20. The network entity of claim 15, wherein the first bandwidth is frequency range 1 (FR1) and the second bandwidth is frequency range 2 (1-R2).

21. The network entity of claim 15, wherein the first bandwidth is associated with a first cell and the second bandwidth is associated with a plurality of second cells.

22. The network entity of claim 15, wherein the first bandwidth is associated with a first subcarrier spacing and the second bandwidth is associated with a second subcarrier spacing that is smaller than the first subcarrier spacing.

23. The network entity of claim 15, wherein the DCI schedules data on a plurality of cells of the second bandwidth, wherein the scheduling of data on the plurality of cells includes scheduling of data in a first slot or timing of a first cell and in a second slot or timing of a second cell, wherein the first slot or timing is different from the second slot or timing.

24. The network entity of claim 15, wherein the DCI includes a parameter value identifying a set of slots of a set of scheduled cells that are scheduled from a scheduling cell on which the DCI is received.

25. The network entity of claim 15, wherein the DCI includes a parameter value that maps to a common slot or symbol for a set of scheduled cells.

26. The network entity of claim 15, wherein the DCI includes a parameter value that maps to a set of scheduled cells, and wherein the parameter value maps to a first slot or symbol for a first cell, of the set of scheduled cells, and maps to a second slot or symbol, that is different from the first slot or symbol, for a second cell of the set of scheduled cells.

27. A method of wireless communication performed by a user equipment (UE), comprising:
receiving physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and
receiving, in a first bandwidth and in the PDCCH monitoring occasion associated with the set of PDCCH candidates, downlink control information (DCI) scheduling resources on a second bandwidth, wherein the DCI is decoded from the set of PDCCH candidates in accordance with the set of prioritizations.

28. The method of claim 27, further comprising:
receiving, in the second bandwidth, data communications scheduled by the DCI.

29. A method of wireless communication performed by a network entity, comprising:
transmitting physical downlink control channel (PDCCH) configuration information indicating a set of PDCCH candidates for decoding in a PDCCH monitoring occasion and indicating a set of groupings of PDCCH candidates of the set of PDCCH candidates, wherein the set of groupings is associated with a set of prioritizations; and
transmitting, in a first bandwidth and in the PDCCH monitoring occasion associated with the set of PDCCH candidates, downlink control information (DCI) scheduling resources on a second bandwidth, wherein the DCI is decodable from the set of PDCCH candidates in accordance with the set of prioritizations.

30. The method of claim 29, further comprising:
transmitting, in the second bandwidth, data communications scheduled by the DCI.
